(19) United States
(12) Patent Application Publication
(10) Pub. No.: US 2010/0002861 A1
(43) Pub. Date: Jan. 7, 2010

(54) Method for Obtaining Data at an Electronic Communication Device

(75) Inventors: Yan Gao, Bejing (CN); Jin-Yue Chen, Bejing (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/438,806

(22) PCT Filed: Aug. 7, 2007
(86) PCT No.: PCT/US2007/075350

§ 371 Date: Aug. 28, 2009

(30) Foreign Application Priority Data
Aug. 25, 2006 (CN) 200610126212.X

(51) Int. Cl. H04M 3/42

(52) U.S. Cl. 379/207.16; 455/414.1

(57) ABSTRACT

A method for obtaining data at an electronic communication device enables transmission of data in response to a ring back tone. The method comprises transmitting from the electronic communication device to a network a call setup signal for a call to a callee device (step 205). A ring back tone associated with the callee device is then processed at the electronic communication device, wherein the ring back tone is received from the network in response to the call setup signal (step 210). A data request signal then transmitted, in response to the ring back tone, from the electronic communication device to the network (step 215). Data that are received from the network in response to the data request signal are then processed at the electronic communication device (step 220).

### FIELD OF THE INVENTION

The present invention relates generally to advertising and transmitting data through a communication network. In particular, the invention relates to obtaining at an electronic communication device data associated with a ring back tone.

### BACKGROUND OF THE INVENTION

Ring back tones were originally defined as telephone call signaling components that were heard by a calling party after a dialing sequence was completed by the calling party but before a call was answered by a called party. Conventional ring back tones are often different in various countries. In the United States, a conventional ring back tone comprises a 440 Hz tone summed with a 480 Hz tone that is alternately switched on for two seconds and then switched off for four seconds.

More recently, personalized ring back tones, also known as color ring back tones, have been developed. A color ring back tone replaces a conventional ring back tone with a personalized audio, visual or multimedia presentation that is defined by a user of a called telephone or other electronic communication device. Thus, for example, a wireless service subscriber is able to select a music segment, sound, jingle, phrase, message or a multimedia file that is delivered to callers that dial a phone number of the subscriber. Similar to conventional ring back tones, color ring back tones are provided to a calling party after a dialing sequence has been completed but before a call is answered by a called party.

### SUMMARY OF THE INVENTION

According to one aspect, the present invention is a method for obtaining data at an electronic communication device. The method comprises transmitting from the electronic communication device to a network a call setup signal for a call to a callee device. A ring back tone associated with the callee device is then processed at the electronic communication device, wherein the ring back tone is received from the network in response to the call setup signal. A data request signal is then transmitted, in response to the ring back tone, from the electronic communication device to the network. Data that are received from the network in response to the data request signal are then processed at the electronic communication device.

According to another aspect, from the perspective of a communication network, the present invention is a method for providing data to an electronic communication device. The method comprises processing in a network a call setup signal received from the electronic communication device for a call to a callee device. A ring back tone associated with the callee device is then transmitted from the network to the electronic communication device in response to the call setup signal. A data request signal received from the electronic communication device in response to the ring back tone is then processed in the network. Data are then transmitted from the network to the electronic communication device in response to the data request signal.

Advantages of embodiments of the present invention thus include enabling a ring back tone associated with a callee's electronic communication device to be used to advertise data that can be transmitted to a caller's electronic communication device. Data can be implicitly advertised, such as where a ring back tone includes only music that is heard by a caller, or explicitly advertised, such as where a ring back tone includes an audio voice message that describes the data and provides instructions on how to obtain the data.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a message sequence chart illustrating a process in a wireless communication network for obtaining data at a caller telephone, according to some embodiments of the present invention;

FIG. 2 is a general flow diagram illustrating a method for obtaining data at an electronic communication device, according to some embodiments of the present invention; and

FIG. 3 is a general flow diagram illustrating a method, from the perspective of a communication network, for providing data to an electronic communication device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to obtaining data at an electronic communication device. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as left and right, first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

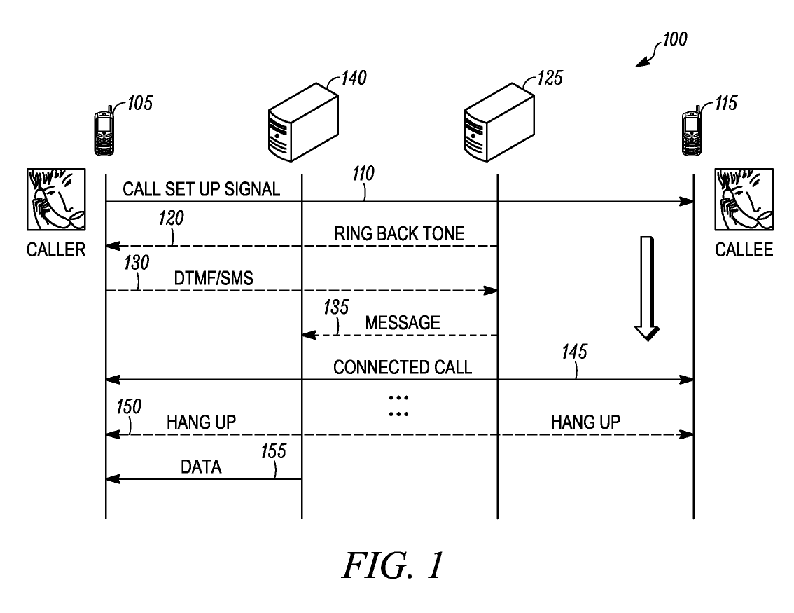

Referring to FIG. 1, a message sequence chart illustrates a process in a wireless communication network 100 for obtaining data at a caller telephone 105, according to some embodiments of the present invention. At line 110, a caller associated with the caller telephone 105 places a call by transmitting a call setup signal through the network 100 to a callee telephone 115 associated with a callee. At line 120, a network component 125, such as, for example, a radio network controller or a base station, transmits a ring back tone associated with the callee telephone 115 to the caller telephone 105.

The ring back tone is then received and processed at the caller telephone 105. The caller is then able to determine whether he or she would like to obtain data associated with the ring back tone. For example, if the ring back tone is a music file, the caller can follow instructions that enable the caller to download a copy of the ring back tone music file to the caller telephone 105. As described in more detail below, such instructions can be provided to a caller in various ways. Such instructions can define, for example, a data request signal comprising a dual-tone multi-frequency (DTMF) signal that can be transmitted, while a ring back tone is playing, from the caller telephone 105 to the network 100 in order to obtain a copy of the ring back tone.

Thus at line 130, if the caller would like to obtain data associated with the ring back tone, a data request signal is transmitted from the caller telephone 105 to the network component 125. At line 135, the network component 125 then transmits a message to a server 140 associated with the network 100, where the message indicates that the caller telephone 105 has requested data associated with the ring back tone.

At line 145, a call between the caller telephone 105 and the callee telephone 115, which call was initiated by the call setup signal at line 110, is connected. At line 150, the call between the caller telephone 105 and the callee telephone 115 is completed and then disconnected when the caller and the callee hang up. At line 155, data associated with the ring back tone are then pushed from the server 140 to the caller telephone 105.

Therefore, according to some embodiments of the present invention, the caller associated with the caller telephone 105 is able to obtain data from the network 100 based on information provided by a ring back tone. The ring back tone can be defined by a callee associated with a callee telephone 115. For example, the ring back tone can comprise various types of data such as, for example, music data, text data, video data, voice data, or other audio, visual or multimedia data.

A data request signal is used by an electronic communication device, such as the caller telephone 105, to request data associated with a ring back tone. A data request signal can be any of various types of signals, such as a dual-tone multi-frequency (DTMF) signal or a short message service (SMS) message. For example, a DTMF signal, commonly known as a touch tone signal, can be transmitted from the caller telephone 105 when the caller keys in one or more numbers on a keypad associated with the caller telephone 105. Similarly, a data request signal can be transmitted as an SMS message sent from the caller telephone 105 to a designated number associated with the network 100.

A caller can be provided instructions concerning how to transmit a data request signal in various ways. For example, a network service provider can deliver such instructions to all network subscribers using user manuals, advertisements, broadcast messages, customized user interfaces or other means. Further, such instructions can include various levels of detail. For example, an instruction can specify that when a subscriber hears or views a particular ring back tone when placing a call to a particular callee, the subscriber can obtain that ring back tone as a ring tone associated with all calls from that particular callee by pressing the number “1” on a keypad associated with the subscriber's telephone. The instruction can further specify that the subscriber can obtain a ring back tone as their own ring back tone—which will be transmitted to other callers when a call is placed to the subscriber—by pressing the number “2” on a keypad associated with the subscriber's telephone. Also, the instructions can specify that a DTMF signal resulting from pressing a number on a keypad must be transmitted before a call is answered, thus while a ring back tone associated with a callee is playing, or at anytime after a call setup signal is transmitted and before a connected call is completed.

An example of an instruction, according to an embodiment of the present invention, provided to a network service subscriber from a network service provider is the following: “When you place a call to a callee using our network, if you hear a ring back tone that you like, you can obtain the ring back tone as a ring tone associated with calls from that callee by pressing ‘1’ on your phone keypad while the ring back tone is playing. Also, you can obtain the ring back tone as your own ring back tone by pressing ‘2’ on your phone keypad while the ring back tone is playing. Requested ring back tones will be sent to your phone using over the air provisioning (OTA) following completion of your call to the callee.”

According to some embodiments of the present invention, a ring back tone itself can also comprise instructions concerning transmission of a data request signal. For example, a ring back tone can include an audio voice message that describes how a caller can obtain information concerning a callee associated with the callee telephone 115. Data concerning a callee can include, for example, updated data from a callee's electronic address book; business operating data such as hours of operation, maps and locations; or copies of a ring back tone. Such an audio voice message in a ring back tone can thus comprise an interactive advertisement.

An example of instructions, according to an embodiment of the present invention, provided in a ring back tone concerning transmission of a data request signal is the following message that can be played as an audio voice message in a ring back tone: “Hello. You have reached business X. We will process your call shortly. If you would like us to update your phone with our contact details following this call, please press ‘1’ on your phone keypad now. If you would like your phone to use our ring back tone music as a ring tone when we call you, please press ‘2’ on your phone keypad now.” Such an audio voice message then can be followed by a selection of music until a placed call is connected. If a caller enters one of the DTMF data request signals described in the ring back tone, the requested data described in the ring back tone are then downloaded to the caller's electronic communication device at the completion of the call. Such data can be in any of various forms such as audio files, video files, image files, text files, database files, personal store files, executable program files, document files, or multimedia files.

Embodiments of the present invention can further comprise security features so that only licensed or otherwise authorized users of data are able to obtain data associated with a ring back tone. For example, as known by those skilled in the art, such security features can include algorithms that charge a download fee to a caller and transmit a predetermined portion of the download fee to a copyright owner of data that are transmitted to the caller. Such security features also can be used to improve revenues of network service providers by enabling authorization and accounting of download fees.

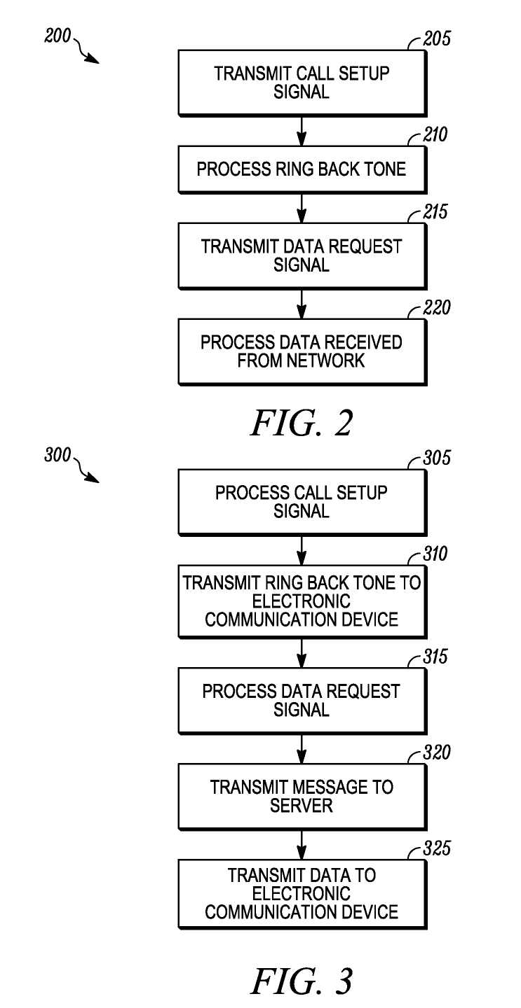

Referring to FIG. 2, a general flow diagram illustrates a method 200 for obtaining data at an electronic communication device, according to some embodiments of the present invention. At step 205, a call setup signal for a call to a callee device is transmitted from the electronic communication device to a network. For example, in FIG. 1 a call setup signal is transmitted at line 110 through the network 100 from the caller telephone 105 to the callee telephone 115.

At step 210, a ring back tone associated with the callee device is processed at the electronic communication device. The ring back tone is received from the network in response to the call setup signal. For example, in FIG. 1 the ring back tone received at line 120 is processed at the caller telephone 105.

At step 215, a data request signal is transmitted from the electronic communication device to the network in response to the ring back tone. For example, in FIG. 1 the data request signal at line 130 is transmitted from the caller telephone 105 to the network component 125.

At step 220, data received at the electronic communication device from the network in response to the data request signal are processed. For example, in FIG. 1 data received at line 155 from the server 140 are processed at the caller telephone 105.

According to some embodiments of the present invention, an electronic communication device can be, for example, a mobile telephone, landline telephone, personal computer, personal digital assistant, or one of various other types of electronic communication devices.

Referring to FIG. 3, a general flow diagram illustrates a method 300, from the perspective of a communication network, for providing data to an electronic communication device. At step 305, a call setup signal received from the electronic communication device for a call to a callee device is processed in the network. For example, in FIG. 1 the call setup signal transmitted at line 110 from the caller telephone 105 to the callee telephone 115 is processed in the network 100.

At step 310, a ring back tone associated with the callee device is transmitted from the network to the electronic communication device in response to the call setup signal. For example, in FIG. 1 the ring back tone at line 120 is transmitted from the network component 125 to the caller telephone 105.

At step 315, a data request signal received from the electronic communication device in response to the ring back tone is processed in the network. For example, in FIG. 1 the data request signal transmitted at line 130 from the caller telephone 105 is processed in the network component 125.

At step 320, a message is transmitted, in response to the data request signal, from a core network component to a push server. The message can indicate that the data request signal has been processed and can identify both the electronic communication device associated with the caller and the callee device. For example, in FIG. 1 the message at line 135 is transmitted from the network component 125 to the server 140.

At step 325, data are transmitted from the network to the electronic communication device in response to the data request signal. For example, in FIG. 1 data are transmitted at line 155 from the server 140 to the caller telephone 105.

Advantages of embodiments of the present invention thus include enabling a ring back tone associated with a callee's electronic communication device to be used to advertise data that can be transmitted to a caller's electronic communication device. Data can be implicitly advertised, such as where a ring back tone includes only music that is heard by a caller, or explicitly advertised, such as where a ring back tone includes an audio voice message that describes the data and provides instructions on how to obtain the data.

The above detailed description provides an exemplary embodiment only, and is not intended to limit the scope, applicability, or configuration of the present invention. Rather, the detailed description of the exemplary embodiment provides those skilled in the art with an enabling description for implementing the exemplary embodiment of the invention. It should be understood that various changes can be made in the function and arrangement of elements and steps without departing from the spirit and scope of the invention as set forth in the appended claims. It will be appreciated that embodiments of the invention described herein may be comprised of one or more conventional processors and unique stored program instructions that control the one or more processors to implement, in conjunction with certain non-processor circuits, some, most, or all of the functions of obtaining data at an electronic communication device as described herein. The non-processor circuits may include, but are not limited to, a radio receiver, a radio transmitter, signal drivers, clock circuits, power source circuits, and user input devices. As such, these functions may be interpreted as steps of a method for obtaining data at an electronic communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for obtaining data at an electronic communication device, the method comprising:
transmitting from the electronic communication device to a network a call setup signal for a call to a callee device.
processing, at the electronic communication device, a ring back tone associated with the callee device, wherein the ring back tone is received from the network in response to the call setup signal;
transmitting, in response to the ring back tone, a data request signal from the electronic communication device to the network; and
processing data at the electronic communication device that are received from the network in response to the data request signal.

2. The method of claim 1, wherein the ring back tone is a color ring back tone.

3. The method of claim 1, wherein the ring back tone comprises instructions concerning transmission of the data request signal.

4. The method of claim 1, wherein the data request signal comprises a dual-tone multi-frequency signal.

5. The method of claim 1, wherein the data request signal comprises a short message service message.

6. The method of claim 1, wherein the data received from the network in response to the data request signal comprise the ring back tone.

7. The method of claim 1, wherein the data received from the network in response to the data request signal comprise information concerning a callee associated with the callee device.

8. The method of claim 1, wherein the data received from the network in response to the data request signal are received and processed at the electronic communication device after a call is completed between the electronic communication device and the callee device.

9. A method for providing data to an electronic communication device, the method comprising:
processing in a network a call setup signal received from the electronic communication device for a call to a callee device.
transmitting, from the network to the electronic communication device, in response to the call setup signal, a ring back tone associated with the callee device;
processing, in the network, a data request signal received from the electronic communication device in response to the ring back tone; and
transmitting data from the network to the electronic communication device in response to the data request signal.

10. The method of claim 9, wherein the ring back tone is a color ring back tone.

11. The method of claim 9, wherein the ring back tone comprises instructions concerning transmission of the data request signal.

12. The method of claim 9, wherein the data request signal comprises a dual-tone multi-frequency signal.

13. The method of claim 9, wherein the data request signal comprises a short message service message.

14. The method of claim 9, wherein the data transmitted to the electronic communication device in response to the data request signal comprise the ring back tone.

15. The method of claim 9, wherein the data transmitted to the electronic communication device in response to the data request signal comprise information concerning a callee associated with the callee device.

16. The method of claim 9, wherein the data transmitted to the electronic communication device in response to the data request signal are transmitted after a call is completed between the electronic communication device and the callee device.

17. The method of claim 9, further comprising transmitting a message, in response to the data request signal, from a core network component to a push server, indicating that the data request signal has been processed and identifying the electronic communication device and the callee device.
